(19) United States
(12) Patent Application Publication
(10) Pub. No.: US 2026/0360916 A1
(43) Pub. Date: Nov. 12, 2026

(54) ANNULAR BREATHING MULTI-FUNCTION PRESSURE RELIEF VALVE ASSEMBLIES

(71) Applicant: FORD GLOBAL TECHNOLOGIES, LLC, Dearborn, MI (US)

(72) Inventors: Samuel Jeffrey Tomlinson, Farmington Hills, MI (US); Xiaogang Zhang, Novi, MI (US)

(21) Appl. No.: 19/201,410

(22) Filed: May 7, 2025

(51) Int. Cl. H01M 50/342; F16K 17/16

(52) U.S. Cl. CPC H01M 50/3425; F16K 17/162; H01M 2200/20; H01M 2220/20

(57) ABSTRACT

Multi-function valve assemblies are provided for use in automotive components, such as traction battery packs, for example. An exemplary multi-function valve assembly may be configured to provide both pressure equalization and degassing functions in a single component. The multi-function valve assembly may include a valve body, a valve disc, and an annular membrane. The annular membrane is configured to promote radial breathing through the multi-function valve assembly for providing the pressure equalization functionality. The valve body, the valve disc, and/or the annular membrane may function as a pop-off valve for providing the degassing functionality when a pressure inside an enclosure wall to which the multi-function valve assembly is mounted exceeds a threshold.

### TECHNICAL FIELD

This disclosure relates to multi-function valve assemblies for use within automotive components, such as traction battery packs, for example.

### BACKGROUND

Many automotive components require a gas-tight housing design. The components may also require pressure equalization due to temperature fluctuations.

### SUMMARY

A multi-function valve assembly according to an exemplary aspect of the present disclosure includes, among other things, a valve body including an internal bore, a valve disc received within the internal bore, and an annular membrane positioned within the internal bore at a location between the valve disc and the valve body. The annular membrane is configured to establish an annular gas path for performing a pressure equalization function of the multi-function valve assembly.

In a further non-limiting embodiment of the foregoing multi-function valve assembly, the valve disc is a solid disk-shaped structure.

In a further non-limiting embodiment of either of the foregoing multi-function valve assemblies, the annular membrane is a porous ring-shaped structure.

In a further non-limiting embodiment of any of the foregoing multi-function valve assemblies, the annular membrane is secured to the valve disc.

In a further non-limiting embodiment of any of the foregoing multi-function valve assemblies, the annular membrane circumscribes a plurality of mounting blocks that protrude from a rear surface of the valve disc.

In a further non-limiting embodiment of any of the foregoing multi-function valve assemblies, the annular membrane circumscribes a cylindrical flange that protrudes from a rear surface of the valve disc.

In a further non-limiting embodiment of any of the foregoing multi-function valve assemblies, the annular membrane is secured to the valve body.

In a further non-limiting embodiment of any of the foregoing multi-function valve assemblies, the annular membrane circumscribes a cylindrical flange of the valve body.

In a further non-limiting embodiment of any of the foregoing multi-function valve assemblies, at least a portion of the multi-function valve assembly is configured to eject from the valve body to perform a degassing function of the multi-function valve assembly.

In a further non-limiting embodiment of any of the foregoing multi-function valve assemblies, a subassembly of the valve disc and the annular membrane is configured to eject from the valve body to perform the degassing function.

In a further non-limiting embodiment of any of the foregoing multi-function valve assemblies, the valve disc is configured to eject from the valve body to perform the degassing function.

In a further non-limiting embodiment of any of the foregoing multi-function valve assemblies, an entirety of the multi-function valve assembly is configured to eject from an enclosure wall to perform a degassing function of the multi-function valve assembly.

A traction battery pack according to another exemplary aspect of the present disclosure includes, among other things, an enclosure wall including an opening, and a multi-function valve assembly received within the opening. The multi-function valve assembly includes a pop-off valve that is configured to eject from either the enclosure wall or the multi-function valve assembly to expose the opening when a pressure inside the traction battery pack exceeds a predefined threshold.

In a further non-limiting embodiment of the foregoing traction battery pack, the pop-off valve is established by a valve body, a valve disc, and an annular membrane of the multi-function valve assembly.

In a further non-limiting embodiment of either of the foregoing traction battery packs, the pop-off valve is established by a valve disc and an annular membrane of the multi-function valve assembly.

In a further non-limiting embodiment of any of the foregoing traction battery packs, a subassembly of the valve disc and the annular membrane is configured to eject from a valve body of the multi-function valve assembly when the pressure inside the traction battery pack exceeds the predefined threshold.

In a further non-limiting embodiment of any of the foregoing traction battery packs, the pop-off valve is established by a valve disc of the multi-function valve assembly.

In a further non-limiting embodiment of any of the foregoing traction battery packs, the valve disc is configured to eject from a valve body of the multi-function valve assembly when the pressure inside the traction battery pack exceeds the predefined threshold.

In a further non-limiting embodiment of any of the foregoing traction battery packs, an annular membrane of the multi-function valve assembly is configured to establish an annular gas path for equalizing a pressure between an interior of the traction battery pack and an atmosphere outside the traction battery pack.

A method of manufacturing an annular membrane for a multi-function valve assembly, according to another exemplary aspect of the present disclosure includes, among other things, cutting a strip from a roll of a material, folding the strip such that a first end of the strip overlaps a second end of the strip, and joining the first end to the second end with a fastener, thereby forming the annular membrane.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle having a traction battery pack.

FIG. 2 illustrates a traction battery pack of the electrified vehicle of FIG. 1.

FIG. 3 illustrates another exemplary traction battery pack for an electrified vehicle.

FIG. 4 is a cross-sectional view through section 4-4 of FIG. 2 and illustrates an exemplary multi-function valve assembly of the traction battery pack.

FIG. 5 is a front view of the multi-function valve assembly of FIG. 4.

FIG. 6 is a rear view of a subassembly of the multi-function valve assembly of FIG. 4.

FIG. 7 is a rear view of another subassembly of the multi-function valve assembly of FIG. 4.

FIG. 8 schematically illustrates a first exemplary position of the multi-function valve assembly of FIG. 4.

FIG. 9 schematically illustrates a second exemplary position of the multi-function valve assembly of FIG. 4.

FIGS. 10, 11, and 12 illustrate another exemplary multi-function valve assembly.

FIGS. 13, 14, and 15 illustrate yet another exemplary multi-function valve assembly.

FIG. 16 schematically illustrates a method for manufacturing an annular membrane for a multi-function valve assembly.

### DETAILED DESCRIPTION

This disclosure details exemplary multi-function valve assemblies for use in automotive components, such as traction battery packs, for example. An exemplary multi-function valve assembly may be configured to provide both pressure equalization and degassing functions in a single component. The multi-function valve assembly may include a valve body, a valve disc, and an annular membrane. The annular membrane is configured to promote radial breathing through the multi-function valve assembly for providing the pressure equalization functionality. The valve body, the valve disc, and/or the annular membrane may function as a pop-off valve for providing the degassing functionality when a pressure inside an enclosure wall to which the multi-function valve assembly is mounted exceeds a threshold. These and other features are discussed in greater detail in the following paragraphs of this detailed description.

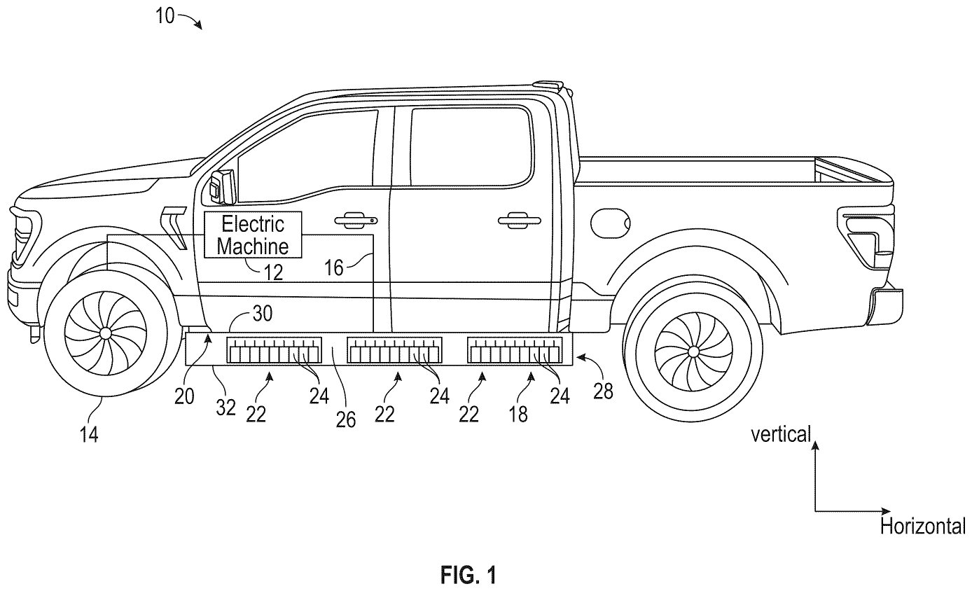

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover 30 and an enclosure tray 32, for example. The enclosure cover 30 may be secured (e.g., bolted, welded, adhered, etc.) to the enclosure tray to provide the interior area 26. The size, shape, and overall configuration of the enclosure assembly 28 is not intended to limit this disclosure.

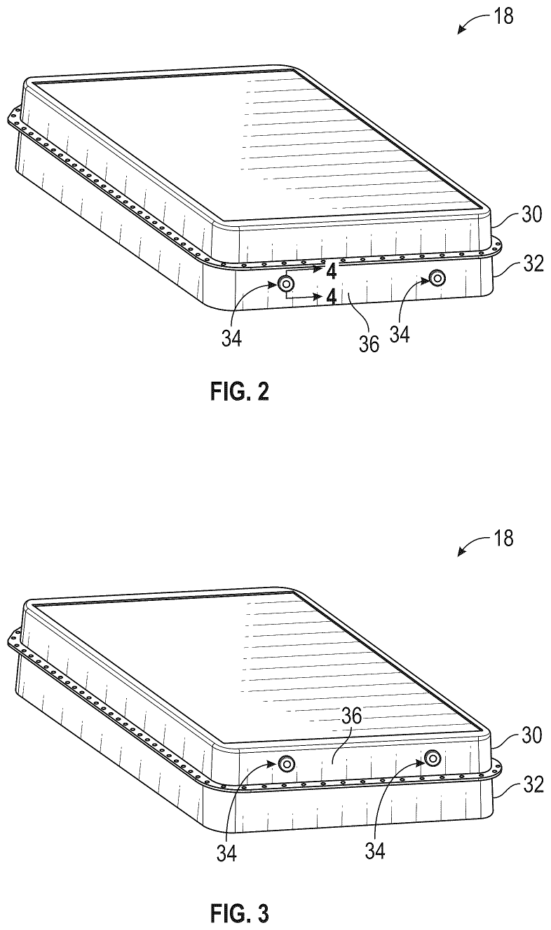

Referring now to FIG. 2, with continued reference to FIG. 1, the traction battery pack 18 may additionally include one or more multi-function valve assemblies 34 (hereinafter referred to as “valve assemblies” or individually as “valve assembly”). Although two valve assemblies 34 are shown, the traction battery pack 18 may include a greater or fewer number of such devices.

Each valve assembly 34 can be disposed within a wall 36 of the enclosure assembly 28. In an embodiment, the wall 36 is part of the enclosure tray 32. In another embodiment, the wall 36 is part of the enclosure cover 30 (see FIG. 3). The precise mounting location of each valve assembly 34 could vary and is therefore not intended to limit this disclosure.

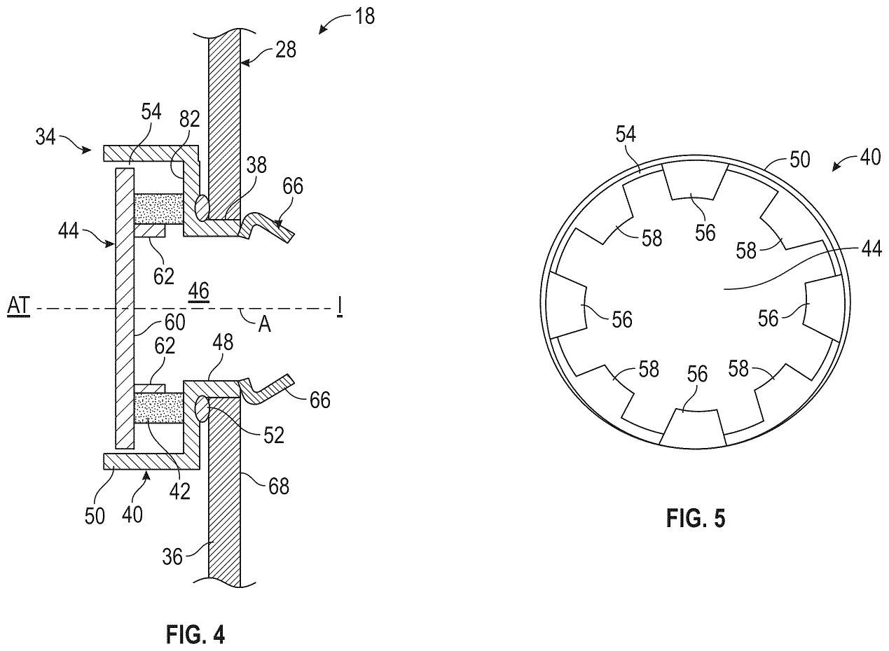

Referring now to FIGS. 4-9, with continued reference to FIGS. 1-2, each valve assembly 34 may be disposed within an opening 38 of the wall 36. The valve assembly 34 may be mounted within the opening 38 in any known manner.

The valve assembly 34 may include a valve body 40, an annular membrane 42, and a valve disc 44. The valve body 40 may be a plastic component or a metallic component and may include a single-piece structure or a multi-piece structure. The size and shape of the valve body 40 are not intended to limit this disclosure.

The valve body 40 may include an internal bore 46 that extends along a longitudinal centerline axis A between an inner section 48 and an outer section 50. The inner section 48 interfaces with the opening 38 of the wall 36, and the outer section 50 protrudes outwardly of the wall 36. The outer section 50 is therefore located further away from an interior I of the enclosure assembly 28 of the traction battery pack 18 compared to the inner section 48.

The outer section 50 and the inner section 48 may each be cylindrical shaped. The outer section 50 may include a larger diameter than the inner section 48, thereby configuring the internal bore 46 to exhibit a stepped configuration. However, other configurations are contemplated within the scope of this disclosure.

A seal 52 may be positioned between the valve body 40 and the wall 36. The seal 52 may be configured to seal an interface between the inner section 48 of the valve body 40 and the wall 36. In an embodiment, the seal 52 is an O-ring seal. However, other types of seals could be utilized within the scope of this disclosure.

The valve body 40 may additionally include one or more retention clips 66 for retaining the valve body 40 within the opening 38 of the wall 36. The retention clips 66 may be curved structures and may each be attached to or integrally formed with the inner section 48 of the valve body 40. Each retention clip 66 may be configured to engage an interior surface 68 of the wall 36 for retaining the valve body 40 to the wall 36. In an embodiment, the valve body 40 includes three retention clips 66 that are spaced 120 degrees apart from one another at the rear surface of the inner section 48 of the valve body 40.

Each retention clip 66 may be constructed from either plastic or metallic materials. The material make-up of the retention clips 66 may be specifically tuned to provide a desired level of flexibility when deflected or otherwise distorted. As further discussed below, the retention clips 66 may be specifically configured to allow the valve body 40 to eject or otherwise disengage from the wall 36 when a pressure within the interior I exceeds a predefined threshold.

The valve disc 44 may be received within the portion of the internal bore 46 provided by the outer section 50 of the valve body 40. The valve disc 44 may be a solid disk-shaped structure that is arranged to extend coaxially along the longitudinal centerline axis A. An annular gap 54 may extend radially between a radially outer surface of the valve disc 44 and a radially inner surface of the outer section 50 of the valve body 40.

The valve body 40 and the valve disc 44 may include a combination of features designed for inserting and retaining the valve disc 44 within the internal bore 46. For example, the outer section 50 of the valve body 40 may include a plurality of retention tabs 56 that protrude inwardly from the outer section 50 and may be circumferentially spaced from one another about the circumference of the outer section 50 (see, for example, FIG. 5). The valve disc 44 may correspondingly include a plurality of cut-outs 58 formed in its outer circumferential surface and which are circumferentially spaced apart from one another (see, for example, FIG. 5). The cut-outs 58, which can include a shape that is the dimensional opposite of the retention tabs 56, may be aligned to the retention tabs 56 to allow the valve disc 44 to be inserted into the internal bore 46. The valve disc 44 may then be rotated relative to the valve body 40, such as by a quarter-turn, for example, to retain the valve disc 44 in place within the internal bore 46.

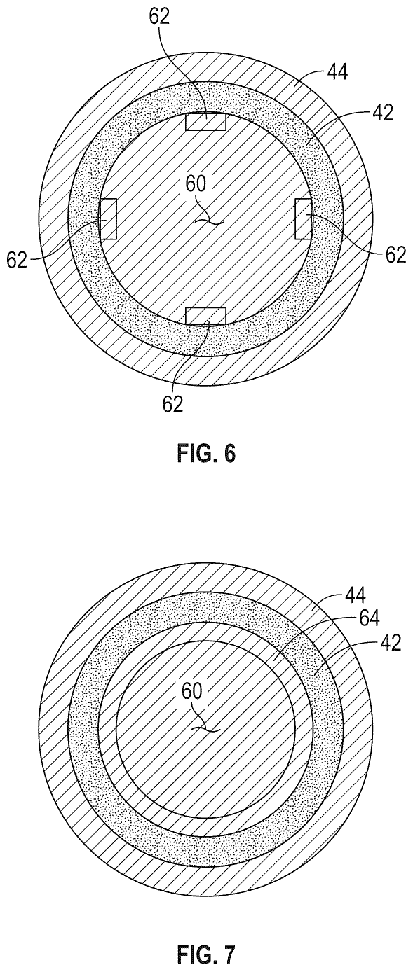

The valve disc 44 may include features designed for mounting the annular membrane 42 to the valve disc 44. For example, in an embodiment (see FIGS. 4 and 6), a plurality of circumferentially spaced mounting blocks 62 may protrude in a direction away from a rear surface 60 of the valve disc 44. In another embodiment, a cylindrical flange 64 may protrude in a direction away from the rear surface 60 of the valve disc 44 (sese FIG. 7). The annular membrane 42 may be positioned to circumscribe the mounting blocks 62 or the cylindrical flange 64 in order to mount the annular membrane 42 to the valve disc 44. The annular membrane 42 may optionally be adhered to the rear surface 60 of the valve disc 44 for augmenting the connection of these components. Notably, the annular membrane 42 may be mounted to the valve disc 44 prior to inserting and retaining the valve disc 44 within the internal bore 46 of the valve body 40.

The annular membrane 42 may be positioned within the internal bore 46 in the space extending between the valve disc 44 and the valve body 40. In an assembled condition of the valve assembly 34, the annular membrane 42 may abut against a rear wall 82 of the valve body 40. The rear wall 82 may connect between the inner section 48 and the outer section 50 of the valve body 40 and demarcates the location where the internal bore 46 changes diameter.

The annular membrane 42 may be a porous ring-shaped structure that is arranged to extend coaxially along the longitudinal centerline axis A. In an embodiment, the annular membrane 42 is made from a non-woven polytetrafluoroethylene (PTFE). In another embodiment, the annular membrane 42 is made from polyester. However, other materials or combinations of materials could be utilized to construct the annular membrane 42 within the scope of this disclosure.

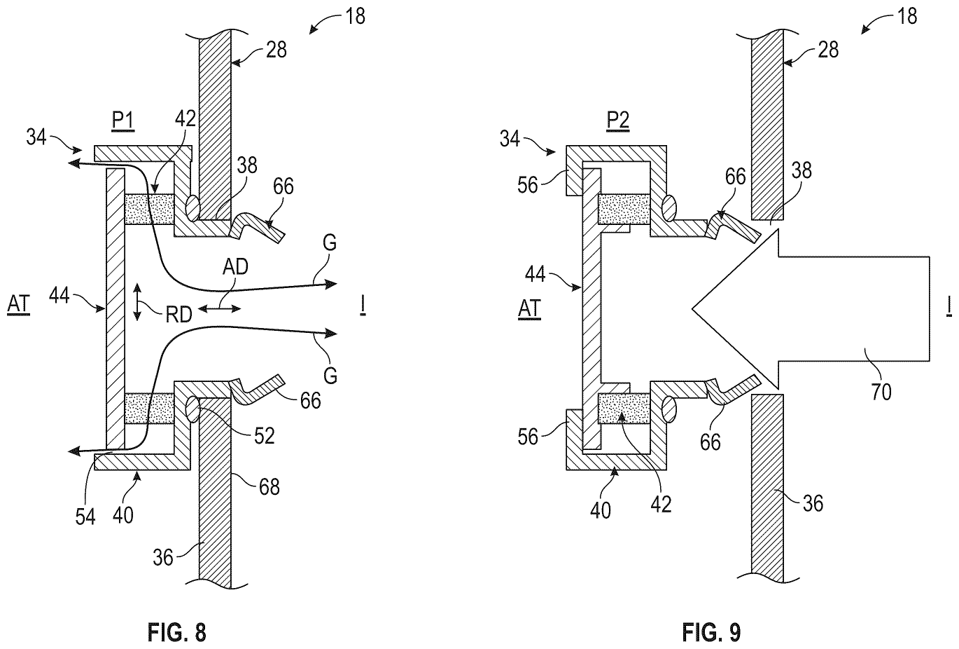

FIG. 8 shows a first or default position P1 of the valve assembly 34. In this position, the annular membrane 42 of the valve assembly 34 is configured to allow gases G to flow in and out of the traction battery pack 18 while preventing moisture, particle contaminants, etc. from entering the interior I during normal operating conditions. The annular membrane 42 may therefore provide pressure equalization between the interior I of the traction battery pack 18 and an atmosphere AT outside the wall 36 of the enclosure assembly 28 of the traction battery pack. Notably, the valve body 40 of the valve assembly 34 remains attached to the wall 36 during the entirety of the pressure equalization procedure.

During the pressure equalization procedure that is generally described in the preceding paragraph, the gases G may move in both an axial direction AD and a radial direction RD relative to the valve assembly 34. However, the gases G must move in the radial direction RD in order to radially pass through annular membrane 42 before being discharged from the valve assembly 34 through the annular gap 54. The annular membrane 42 therefore promotes a “radial breathing” design for providing the pressure equalization functionality that is schematically shown in FIG. 8.

FIG. 9 shows a second or degassing position P2 of the valve assembly 34. The valve assembly 34, including each of the valve body 40, the annular membrane 42, and the valve disc 44, may be ejected from the wall 36 in order to move from the default position P1 shown in FIG. 8 to the degassing position P2 shown in FIG. 9. This may occur, for example, during a thermal event of the traction battery pack 18. During such a thermal event, a gaseous mixture 70 (e.g., gases, effluent particles, and/or other byproducts) can increase the pressure inside the interior I of the enclosure assembly 28 of the traction battery pack 18.

When the pressure in the interior I exceeds a predefined threshold, and in particular the threshold at which the retention clips 66 are capable of retaining the valve assembly 34 within the opening 38 of the wall 36, the entirety of the valve assembly 34 may eject and thus become dislodged from the opening 38. The valve assembly 34 may therefore function as a pop-off valve for exposing the opening 38. Once the valve assembly 34 has ejected from the wall 36 in this manner, the gaseous mixture 70 may be discharged from the traction battery pack 18 through the now exposed opening 38.

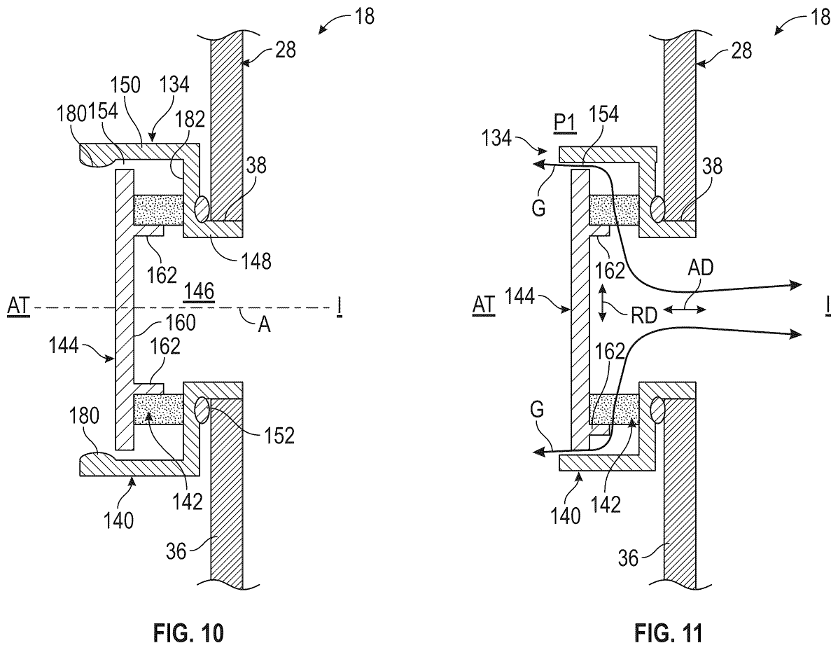

FIGS. 10, 11, and 12 illustrate another exemplary multi-function valve assembly 134. The valve assembly 134 is similar to the valve assembly 34 described above, however, in this embodiment, and as further discussed below, only a subassembly of the valve assembly 134 is designed to eject or otherwise become dislodged from the remaining portions of the valve assembly 134 during a thermal event of the traction battery pack 18.

The valve assembly 134 may include a valve body 140, an annular membrane 142, and a valve disc 144. The valve body 140 may include an internal bore 146 that extends along a longitudinal centerline axis A between an inner section 148 and an outer section 150. The inner section 148 interfaces with the opening 38 of the wall 36 of the traction battery pack 18, and the outer section 150 protrudes outwardly of the wall 36. The outer section 150 is therefore located further away from an interior I of the enclosure assembly 28 of the traction battery pack 18 compared to the inner section 148.

The outer section 150 and the inner section 148 may each be cylindrical shaped. The outer section 150 may include a larger diameter than the inner section 148, thereby configuring the internal bore 146 to include a stepped configuration. However, other configurations are contemplated within the scope of this disclosure.

A seal 152 may be positioned between the valve body 140 and the wall 36. The seal 152 may be configured to seal an interface between the inner section 148 of the valve body 140 and the wall 36. In an embodiment, the seal 152 is an O-ring seal. However, other types of seals could be utilized within the scope of this disclosure.

The valve disc 144 may be received within the portion of the internal bore 146 provided by the outer section 150 of the valve body 140. The valve disc 144 may be a solid disk-shaped structure that is arranged to extend coaxially along the longitudinal centerline axis A. An annular gap 154 may extend radially between a radially outer surface of the valve disc 144 and a radially inner surface of the outer section 150 of the valve body 140.

The valve body 140 may include features designed for retaining the valve disc 144 within the internal bore 146. For example, the outer section 150 of the valve body 140 may include a plurality of retention beads 180 that protrude inwardly from the outer section 150 and may be circumferentially spaced from one another about the circumference of the outer section 150. The retention beads 180 may protrude inwardly from the outer section 150 by a lesser distance than the retention tabs 56 of the valve assembly 34 described above. The retention beads 180 are thus designed to retain the valve disc 144 in place within the internal bore 146 during normal operating conditions but allow the valve disc 144 to be released from the internal bore 146 when the pressure inside the interior I of the traction battery pack 18 exceeds a threshold.

The annular membrane 142 may be secured to the valve disc 144. In an embodiment, the valve disc 144 includes a plurality of circumferentially spaced mounting blocks 162 that protrude in a direction away from a rear surface 160 of the valve disc 144. The annular membrane 142 may circumscribe the mounting blocks 162 to mount the annular membrane 142 to the valve disc 144. The annular membrane 142 could optionally be adhered to the rear surface 160 of the valve disc 144 for augmenting the connection of these components.

The annular membrane 142 may be positioned within the internal bore 146 in the space extending between the valve disc 144 and the valve body 140. In an assembled condition of the valve assembly 134, the annular membrane 142 may abut against a rear wall 182 of the valve body 140. The rear wall 182 may connect between the inner section 148 and the outer section 150 of the valve body 140 and demarcates a location where the internal bore 146 changes diameter.

The annular membrane 142 may be a porous ring-shaped structure that is arranged to extend coaxially along the longitudinal centerline axis A. In an embodiment, the annular membrane 142 is made from a non-woven polytetrafluoroethylene (PTFE). In another embodiment, the annular membrane 142 is made from polyester. However, other materials or combinations of materials could be utilized to construct the annular membrane 142 within the scope of this disclosure.

FIG. 11 shows a first or default position P1 of the valve assembly 134. In this position, the annular membrane 142 of the valve assembly 34 is configured to allow gases G to flow in and out of the traction battery pack 18 while preventing moisture, particle contaminants, etc. from entering the interior I during normal operating conditions. The annular membrane 142 may therefore provide pressure equalization between the interior I of the traction battery pack 18 and an atmosphere AT outside the wall 36 of the enclosure assembly 28 of the traction battery pack 18. Notably, the valve body 140 of the valve assembly 134 remains attached to the wall 36 during the entirety of the pressure equalization procedure.

During the pressure equalization procedure that is generally described in the preceding paragraph, the gases G may move in both an axial direction AD and a radial direction RD relative to the valve assembly 134. However, the gases G must move in the radial direction RD in order to radially pass through annular membrane 142 before being discharged from the valve assembly 134 through the annular gap 154. The annular membrane 142 therefore promotes a “radial breathing” design for providing the pressure equalization functionality that is schematically shown in FIG. 11.

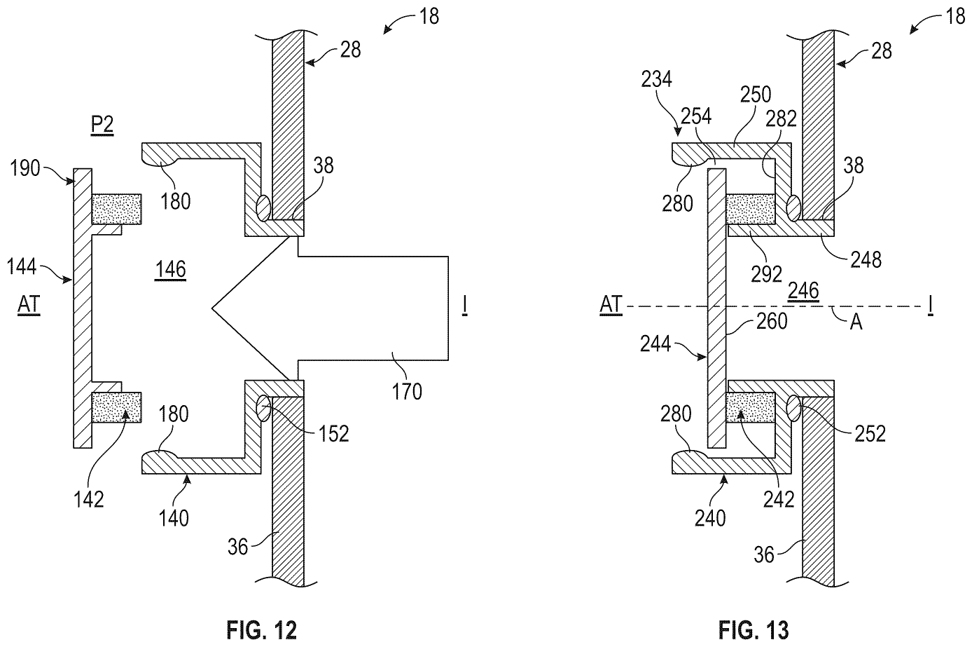

FIG. 12 shows a second or degassing position P2 of the valve assembly 134. A subassembly 190 of the valve assembly 134, which in this implementation includes the valve disc 144 and the annular membrane 142, may be ejected from the valve body 140 in order to transition the valve assembly 134 from the default position P1 shown in FIG. 11 to the degassing position P2 shown in FIG. 12. This may occur, for example, during a thermal event of the traction battery pack 18. During such a thermal event, a gaseous mixture 170 (e.g., gases, effluent particles, and/or other byproducts) can increase the pressure inside the interior I of the enclosure assembly 28 of the traction battery pack 18.

When the pressure of the interior I exceeds a predefined threshold, and in particular the threshold at which the retention beads 180 are capable of retaining the valve disc 144 within the internal bore 146, the subassembly 190 of the valve assembly 134 may eject from the valve body 140. The subassembly 190 may therefore function as a pop-off valve. Once the subassembly 190 has been dislodged in this manner, the gaseous mixture 170 may be discharged from the traction battery pack 18 through the now exposed opening 38.

FIGS. 13, 14, and 15 illustrate yet another exemplary multi-function valve assembly 234. The valve assembly 234 is similar to the valve assembly 134 described above, however, in this embodiment, and is further discussed below, only a valve disc 244 of the valve assembly 234 is designed to eject or otherwise dislodge from the remaining portions of the valve assembly 234 during a thermal event of the traction battery pack 18.

The valve assembly 234 may include a valve body 240, an annular membrane 242, and the valve disc 244. The valve body 240 may include an internal bore 246 that extends along a longitudinal centerline axis A between an inner section 248 and an outer section 250. The inner section 248 interfaces with the opening 38 of the wall 36 of the traction battery pack 18, and the outer section 250 protrudes outwardly of the wall 36. The outer section 250 is therefore located further away from an interior I of the enclosure assembly 28 of the traction battery pack 18 compared to the inner section 248.

The outer section 250 and the inner section 248 may each be cylindrical shaped. The outer section 250 may include a larger diameter than the inner section 248, thereby configuring the internal bore 246 to include a stepped configuration. However, other configurations are contemplated within the scope of this disclosure.

A seal 252 may be positioned between the valve body 240 and the wall 36. The seal 252 may be configured to seal an interface between the inner section 248 of the valve body 240 and the wall 36. In an embodiment, the seal 252 is an O-ring seal. However, other types of seals could be utilized within the scope of this disclosure.

The valve disc 244 may be received within the portion of the internal bore 246 provided by the outer section 250 of the valve body 240. The valve disc 244 may be a solid disk-shaped structure that is arranged to extend coaxially along the longitudinal centerline axis A. An annular gap 254 may extend radially between a radially outer surface of the valve disc 244 and a radially inner surface of the outer section 250 of the valve body 240.

The valve body 240 may include features designed for retaining the valve disc 244 within the internal bore 246. For example, the outer section 250 of the valve body 240 may include a plurality of retention beads 280 that protrude inwardly from the outer section 250 and may be circumferentially spaced from one another about the circumference of the outer section 250. The retention beads 280 may protrude inwardly from the outer section 250 by a lesser distance than the retention tabs 56 of the valve assembly 34 described above. The retention beads 280 are thus designed to retain the valve disc 244 in place within the internal bore 246 during normal operating conditions but allow the valve disc 244 to be ejected from the internal bore 246 when a pressure inside the interior I of the traction battery pack 18 exceeds a threshold.

The annular membrane 242 may be positioned within the internal bore 246 in the space extending between the valve disc 244 and the valve body 240. In an assembled condition of the valve assembly 234, the annular membrane 242 may abut against a rear wall 282 of the valve body 240. The rear wall 282 may connect between the inner section 248 and the outer section 250 of the valve body 140 and demarcates a location where the internal bore 246 changes diameter.

In this embodiment, the annular membrane 242 may be secured to the valve body 240 rather than to the valve disc 244. For example, the valve body 240 may include a cylindrical flange 292 that protrudes from the rear wall 282 in a direction opposite from the inner section 248 of the valve body 240. The annular membrane 242 may be positioned to circumscribe the cylindrical flange 292 in order to mount the annular membrane 242 to the valve body 240. The cylindrical flange 292 may terminate prior to contacting a rear surface 260 of the valve disc 244 in order to maintain a radial breathing gas path through the annular membrane 242. The annular membrane 242 could optionally be adhered to the rear wall 282 of the valve body 240 for augmenting the connection of these components.

The annular membrane 242 may be a porous ring-shaped structure that is arranged to extend coaxially along the longitudinal centerline axis A. In an embodiment, the annular membrane 242 is made from a non-woven polytetrafluoroethylene (PTFE). In another embodiment, the annular membrane 242 is made from polyester. However, other materials or combinations of materials could be utilized to construct the annular membrane 242 within the scope of this disclosure.

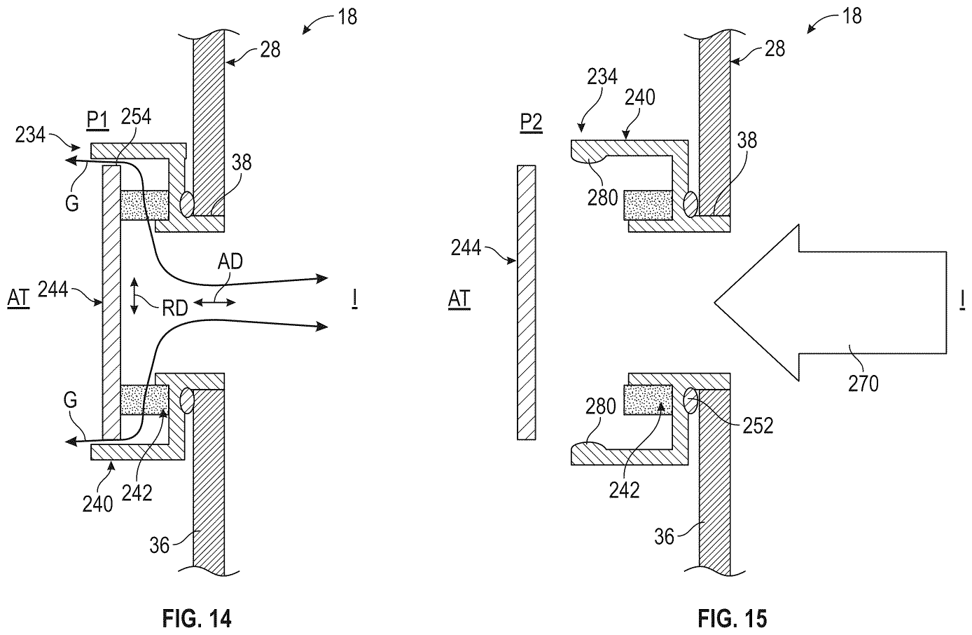

FIG. 14 shows a first or default position P1 of the valve assembly 234. In this position, the annular membrane 242 of the valve assembly 234 is configured to allow gases G to flow in and out of the traction battery pack 18 while preventing moisture, particle contaminants, etc. from entering the interior I during normal operating conditions. The annular membrane 242 may therefore provide pressure equalization between the interior I of the traction battery pack 18 and an atmosphere AT outside the wall 36 of the enclosure assembly 28 of the traction battery pack 18. Notably, an entirety of the valve assembly 234 remains attached to the wall 36 during the pressure equalization procedure.

During the pressure equalization procedure that is generally described in the preceding paragraph, the gases G may move in both an axial direction AD and a radial direction RD relative to the valve assembly 234. However, the gases G must move in the radial direction RD in order to radially pass through annular membrane 242 before being discharged from the valve assembly 234 through the annular gap 254. The annular membrane 242 therefore promotes a “radial breathing” design for providing the pressure equalization functionality that is schematically shown in FIG. 14.

FIG. 15 shows a second or degassing position P2 of the valve assembly 234. The valve disc 244 may eject or otherwise become dislodged from the valve body 240 in order to transition the valve assembly 234 from the default position P1 shown in FIG. 14 to the degassing position P2 shown in FIG. 15. This may occur, for example, during a thermal event of the traction battery pack 18. During such a thermal event, a gaseous mixture 270 (e.g., gases, effluent particles, and/or other byproducts) can increase the pressure inside the interior I of the enclosure assembly 28 of the traction battery pack 18.

When the pressure within the interior I exceeds a predefined threshold, and in particular the threshold at which the retention beads 280 are capable of retaining the valve disc 244 within the internal bore 246, the valve disc 244 of the valve assembly 234 may eject from the valve body 240. The valve disc 244 alone may therefore function as a pop-off valve in this particular implementation. Once the valve disc 244 has been dislodged in this manner, the gaseous mixture 270 may be discharged from the traction battery pack 18 through the now exposed opening 38.

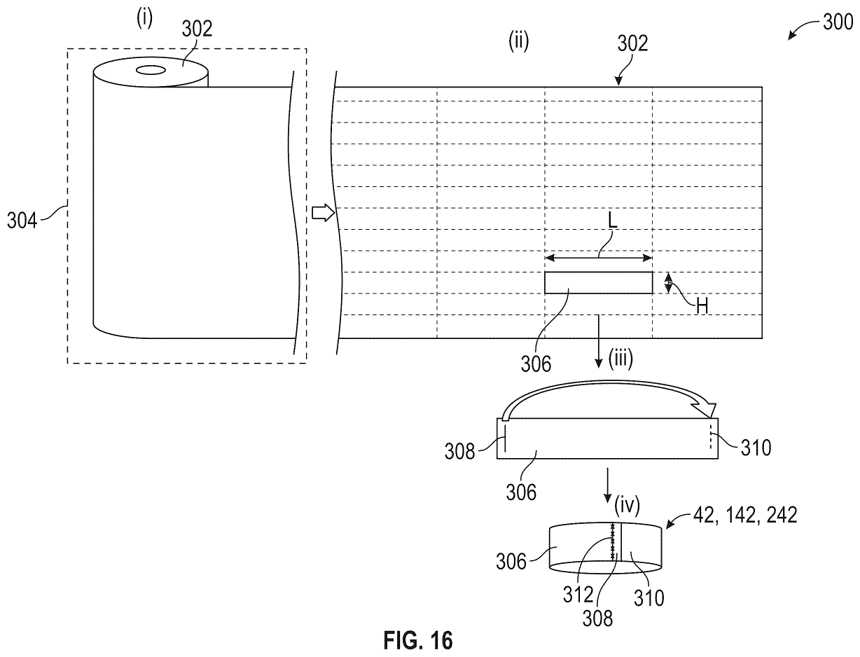

FIG. 16 schematically illustrates an exemplary method 300 for manufacturing the annular membranes 42, 142, 242 described above. Among other benefits, the method 300 may significantly reduce the amount of scrap material that is created when manufacturing the annular membranes 42, 142, 242. It should be understood that fewer or additional steps than are recited below could be performed as part of the method 300, and the specified order of steps shown in FIG. 16 is not intended to limit this disclosure.

First, as schematically illustrated at step (i) of FIG. 16, a roll of material 302 for forming the annular membranes 42, 142, 242 may be delivered to a manufacturing facility 304 where the annular membranes 42, 142, 242 described herein are to be manufactured. The roll of material 302 may be a roll a non-woven PTFE or a roll of polyester, for example.

Next, as schematically illustrated at step (ii) of FIG. 16, a plurality of strips 306 may be formed in the roll of material 302. In an embodiment, the strips 306 are die cut into the roll of material 302. However, other techniques could alternatively be utilized to form the strips 306. Each strip 306 may include a desired length L and a desired height H.

Next, as schematically illustrated at steps (iii) and (iv) of FIG. 16, each strip 306 may be folded into a ring shape in which a first end 308 of the strip 306 is received in an overlapping and abutting relationship relative to a second end 310 of the strip 306. The first end 308 and the second end 310 may then be secured together by a fastener 312 in order to form the annular membrane having the design shown in FIGS. 4-15. In an embodiment, the fastener 312 is a heat weld. However, other types of fasteners could be utilized within the scope of this disclosure.

The exemplary valve assemblies of this disclosure provide a multi-functional design (e.g., capable of degassing and providing pressure equalization) for addressing fluid and gaseous management of traction battery packs or other sealed enclosures. The valve assembles are relatively simply to assemble and manufacture and do not require complex modifications to the traction battery enclosure sealing strategy.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A multi-function valve assembly, comprising:
a valve body including an internal bore;
a valve disc received within the internal bore; and
an annular membrane positioned within the internal bore at a location between the valve disc and the valve body and configured to establish an annular gas path for performing a pressure equalization function of the multi-function valve assembly.

2. The multi-function valve assembly as recited in claim 1, wherein the valve disc is a solid disk-shaped structure.

3. The multi-function valve assembly as recited in claim 1, wherein the annular membrane is a porous ring-shaped structure.

4. The multi-function valve assembly as recited in claim 1, wherein the annular membrane is secured to the valve disc.

5. The multi-function valve assembly as recited in claim 4, wherein the annular membrane circumscribes a plurality of mounting blocks that protrude from a rear surface of the valve disc.

6. The multi-function valve assembly as recited in claim 4, wherein the annular membrane circumscribes a cylindrical flange that protrudes from a rear surface of the valve disc.

7. The multi-function valve assembly as recited in claim 1, wherein the annular membrane is secured to the valve body.

8. The multi-function valve assembly as recited in claim 7, wherein the annular membrane circumscribes a cylindrical flange of the valve body.

9. The multi-function valve assembly as recited in claim 1, wherein at least a portion of the multi-function valve assembly is configured to eject from the valve body to perform a degassing function of the multi-function valve assembly.

10. The multi-function valve assembly as recited in claim 9, wherein a subassembly of the valve disc and the annular membrane is configured to eject from the valve body to perform the degassing function.

11. The multi-function valve assembly as recited in claim 9, wherein the valve disc is configured to eject from the valve body to perform the degassing function.

12. The multi-function valve assembly as recited in claim 1, wherein an entirety of the multi-function valve assembly is configured to eject from an enclosure wall to perform a degassing function of the multi-function valve assembly.

13. A traction battery pack, comprising:
an enclosure wall including an opening; and
a multi-function valve assembly received within the opening, wherein the multi-function valve assembly includes a pop-off valve that is configured to eject from either the enclosure wall or the multi-function valve assembly to expose the opening when a pressure inside the traction battery pack exceeds a predefined threshold.

14. The traction battery pack as recited in claim 13, wherein the pop-off valve is established by a valve body, a valve disc, and an annular membrane of the multi-function valve assembly.

15. The traction battery pack as recited in claim 13, wherein the pop-off valve is established by a valve disc and an annular membrane of the multi-function valve assembly.

16. The traction battery pack as recited in claim 15, wherein a subassembly of the valve disc and the annular membrane is configured to eject from a valve body of the multi-function valve assembly when the pressure inside the traction battery pack exceeds the predefined threshold.

17. The traction battery pack as recited in claim 13, wherein the pop-off valve is established by a valve disc of the multi-function valve assembly.

18. The traction battery pack as recited in claim 17, wherein the valve disc is configured to eject from a valve body of the multi-function valve assembly when the pressure inside the traction battery pack exceeds the predefined threshold.

19. The traction battery pack as recited in claim 13, wherein an annular membrane of the multi-function valve assembly is configured to establish an annular gas path for equalizing a pressure between an interior of the traction battery pack and an atmosphere outside the traction battery pack.

20. A method of manufacturing an annular membrane for a multi-function valve assembly, comprising:
cutting a strip from a roll of a material;
folding the strip such that a first end of the strip overlaps a second end of the strip; and
joining the first end to the second end with a fastener, thereby forming the annular membrane.
